(19) United States
(12) Patent Application Publication
(10) Pub. No.: US 2026/0028906 A1
(43) Pub. Date: Jan. 29, 2026

(54) PRETREATMENT OF HIGH SALINITY PRODUCED WATER FOR MEMBRANE BASED DESALINATION

(71) Applicants: Saudi Arabian Oil Company, Dhahran (SA); GLOBAL WATER PRACTICE, A DIVISION OF NARASIMHAN CONSULTING SERVICES, INC. DBA NCS ENGINEERS, Phoenix, AZ (US)

(72) Inventors: Hasan Al Abdulgader, Dammam (SA); Young Chul Choi, Dhahran (SA); Joon H. Min, Tustin, CA (US); Duaa J. Al Saeed, Al Qatif (SA)

(21) Appl. No.: 18/782,995

(22) Filed: Jul. 24, 2024

(51) Int. Cl. E21B 43/34; C02F 1/00; C02F 1/28; C02F 1/38; C02F 1/44; C02F 5/08; C02F 9/00; C02F 103/10

(52) U.S. Cl. CPC E21B 43/34; C02F 1/004; C02F 1/28; C02F 1/38; C02F 1/441; C02F 5/08; C02F 9/00; C02F 2103/10; C02F 2209/10

(57) ABSTRACT

The technology relates to the pretreatment process of a high salinity produced water stream in a gas oil separation plant (GOSP). The produced water stream includes a salinity of up to 150,000 ppm of total dissolved solids (TDS). The treated produced water stream is processed by a desalination unit integrated in the GOSP, to produce a permeate stream with less than 5000 ppm of TDS and a reject stream. The permeate stream is reused as a wash water stream in the desalter unit of the GOSP, to desalt the crude oil or use it for other beneficial reuse purposes.

### TECHNICAL FIELD

This disclosure relates to methods of pre-treating high salinity produced water by a membrane based desalination process for reuse.

### BACKGROUND

Produced water is wastewater and a by-product from the oil and gas industry. The volume ratio of produced water to oil extracted can sometimes be as high as 5:1. The amount of produced water obtained increases as the oilfield ages. Produced water can account for 80% of the total wastewater generated during oil and gas production in new oil wells and can reach up to 95% for mature fields. A large portion of this water is sent to the injection wells for either pressure maintenance or just disposal.

Medium grade utility water finds use in gas oil separation plants (GOSP). The desalter unit in a GOSP consumes fresh water as wash water. Currently, this wash water need is met by using groundwater or desalinated seawater, which are both limited resources.

### SUMMARY

This disclosure describes methods of pretreatment of produced water from a GOSP for membrane based desalination. The desalination uses a reverse osmosis (RO) or an ultra-high pressure reverse osmosis (UHP-RO) membrane which produces a permeate stream and reject stream. The permeate stream is reused as wash water for the desalter unit.

### BRIEF DESCRIPTION OF DRAWINGS

FIG. 1 is a schematic drawing of a GOSP process that reuses the desalinate produced water as wash water in the desalter.

FIG. 2 is a block flow diagram of a sequence of pretreatment steps for the produced water from a water oil separator (WOSEP).

FIG. 3 is a block flow diagram of a pretreatment process using corrugated plate inceptor (CPI) and induced gas floatation unit (IGF) for the removal of total suspended solids (TSS) and oil.

FIG. 4 is a block flow diagram of a sequence of pretreatment steps for produced water from a WOSEP that utilizes a EQ tank.

FIG. 5 is a block flow diagram of a sequence of pretreatment stages that uses a flash tank to stabilize the pressure of the incoming produced water.

FIG. 6 is a process flow diagram of a GOSP operation for the pretreatment of produced water and desalination using a UHP-RO.

FIG. 7 is the experimental results of the UHP-RO showing the efficiency of removal of total dissolved solids (TDS) and total organic carbon (TOC).

FIG. 8 is a process flow of the proposed technology for a GOSP process to reuse the produced water as a wash water for desalting the crude oil.

### DETAILED DESCRIPTION

Implementations described here provide a method of treating a produced water stream in a GOSP, by a sequence of pre-treatment steps. The pre-treated produced water stream is desalinated by a reverse osmosis (RO) or ultra-high pressure reverse osmosis membrane (UHP-RO). The desalination produces a permeate stream and a reject stream. In implementations described here, the permeate stream is used as a wash water stream for a desalter unit in a GOSP.

An aspect describes a system that includes a sequence of pre-treatment units for a produced water stream in a GOSP. In some implementations, a water oil separator (WOSEP) separates a crude oil and water mixture from a high pressure production trap (HPPT). The WOSEP produces a recovered oil stream and a produced water stream. In some implementations, a first portion of the produced water stream is processed by an injection well.

In some implementations, a second portion of the produced water stream undergoes a sequence of pre-treatment steps prior to desalination. The pre-treatment system includes removal of large oil droplets and small oil droplets, dissolved gases and volatile organic compounds (VOCs), dissolved organics and total petroleum hydrocarbons (TPH), hardness, fine colloidal particles, dissolved oil, and total suspended solids (TSS). A cooling system which includes heat exchangers or an evaporative cooling tower is used to bring down the temperature of the treated produced water stream. A sampling unit is installed to check if the produced water stream meets a pre-determined produced water quality. A desalination unit that includes a nano filtration (NF) membrane, RO membrane, and/or UHP-RO membrane is used to reduce the total dissolved solids (TDS) in produced water.

Treatment of produced water is a complex process due to the varying concentrations and amounts of contaminants present. These contaminants vary depending on the location, maturity, and geological formation of the field. Examples of these contaminants include free oil, emulsified oil, volatile organic compounds, dissolved gases such as hydrogen sulfide and carbon dioxide, inorganic salts, hydrocarbons, suspended solids, and naturally occurring radioactive materials. In addition, the TDS in produced water needs to be reduced and removed as part of the treatment of produced water. The TDS in produced water needs to be lowered from approximately 50,000-150,000 ppm down to less than 5000 ppm, for the water to be reusable in the GOSP, such as wash water in desalters. Low salinity water is used to reduce the salinity of crude oil to protect downstream units from corrosion and scaling.

Reverse osmosis (RO) is a cost-effective desalination technology for saline water with TDS up to 50,000 ppm. For higher salinities, thermal technologies are the only commercial option available for desalination. Thermal technologies include multi-stage distillation (MED), multi-effect flash (MSF), and mechanical vapor compression (MVC). These technologies are energy intensive and require a high CAPEX and OPEX compared to the membrane based desalination. Additionally, the high heat used in the thermal technology results in scale formation issues.

The ultra high-pressure reverse osmosis (UHP-RO) membrane technology in this disclosure enables desalination for higher feed salinity (i.e., >50,000 ppm). The energy requirement for UHP-RO is lesser than that of the available thermal technologies for desalination of high salinity produced water. However, the produced water in the GOSP, which contains high TSS and other contaminants discussed can damage the RO or UHP-RO membranes or reduce the performance if used without pretreatment. Removal of the contaminants will prevent damage to the membrane. The sequence of pre-treatment steps is removal of free oil (large oil droplets), emulsified oil (small oil droplets), dissolved gases, suspended solids (TSS), and sub-micron colloidal contaminants. This sequence of pre-treatment is optimum in terms of performance and cost. There are many possible configurations for the sequence of pre-treatment steps of produced water. The following implementations show various possible steps to enable the treatment of WOSEP effluent for UHP-RO desalination.

The treated produced water can be used for industrial purposes. Examples include but are not limited to wash water for crude oil desalting, hydrostatic testing, fracking, membrane and multimedia backwashing, and water flooding. Additionally, the treated produced water can undergo further treatment steps if necessary and can be utilized for applications that require higher purity water such as boiler feed water or agricultural irrigation water.

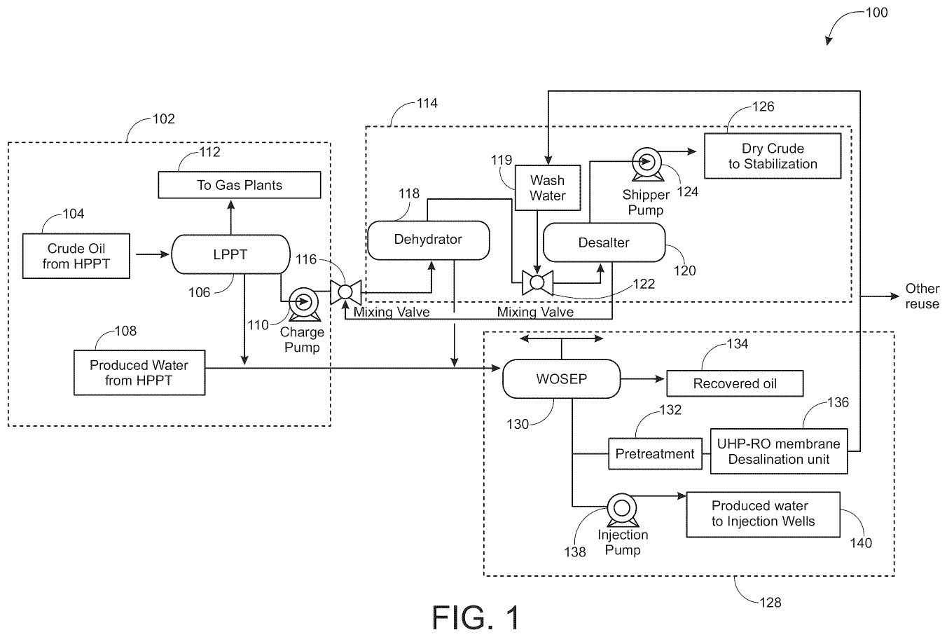

FIG. 1 is a schematic drawing of a GOSP process 100 that reuses the desalinated produced water as wash water in the desalter. In block 102, crude oil mixture 104 is received by a high pressure production trap (HPPT). The HPPT is a three phase separator which separates the crude oil mixture 104 into water, gas, and crude oil with some water content in it. A pressure drop in the HPPT causes the gases to be released from the crude oil. Crude oil remains in the HPPT long enough for the water to settle at the bottom. This time frame is known as residence time. The separated crude oil has some water content. Produced water 108 is separated from the HPPT. The separated crude oil is further processed by a low pressure production trap (LPPT) 106, which is primarily a two phase separator. The LPPT 106 primarily removes the remaining gases from the separated crude oil by a reduction in pressure. LPPT 106 operates at approximately 50 psig. The separated gas flows to a gas plant 112 for further processing. The separated crude oil from the LPPT enters block 114 via a charge pump 110.

At block 114, the separated crude oil is processed by a dehydrator 118, to remove the remaining water content to produce a dry crude oil stream. The charge pump 110 flows the separated crude oil via a mixing valve 116 into the dehydrator 118. The dry crude oil contains salt and other contaminants which depends on the geological formation minerology and the formation brine originally present in the subterranean formation. These salts and contaminants can be removed to prevent corrosion of the downstream processing systems. The dry crude oil is processed by a desalter 120. The dry crude oil flows via a second mixing valve 122 to the desalter 120. The desalter 120 uses wash water 119 to reduce the salinity of the dry crude oil. The wash water with a reduced salinity is obtained from fresh water sources such as ground water or desalinated sea water. The desalting process includes heating the dry crude oil along with wash water and emulsion breaking chemicals. During the desalting process a brine water phase is obtained which contains the extracted salts and impurities. The brine obtained is corrosive and special handling materials are used to remove it from the desalter. The desalted crude oil is processed by a shipper pump 124 to a dry crude stabilization unit 126.

In onshore oil and gas fields, fresh water sources are scarce and sea water is not available nearby. Hence, desalting the dry crude oil becomes an expensive process. In implementations here, the separated produced water 108 from the HPPT is further processed by a water oil separator (WOSEP) 130 in block 128. The separated produced water contains droplets of crude oil in it. It forms oil-in-water emulsions. The WOSEP 130 produces a recovered oil stream 134 and a produced water stream. The produced water stream may have a salinity of up to 150,000 ppm of total dissolved solids (TDS). In some implementations, the produced water stream may have a salinity in the range of 50,000 to 150,000 ppm of TDS. A portion or all of the produced water stream is treated in a pretreatment unit 132, in a particular sequence of steps to remove the contaminants. The treated produced water is desalinated in the desalination unit 136 to produce a permeate stream and a reject stream. The desalination unit 136 can include a nanofiltration, RO, and/or UHP-RO membrane. A portion or all of the permeate stream is reused as wash water for the desalter unit which conserves the usage of fresh water sources. In some implementations, a portion of the produced water stream is sent via an injection pump 138, to an injection well 140 for pressure maintenance, as a fracturing fluid, or for enhanced oil recovery purposes.

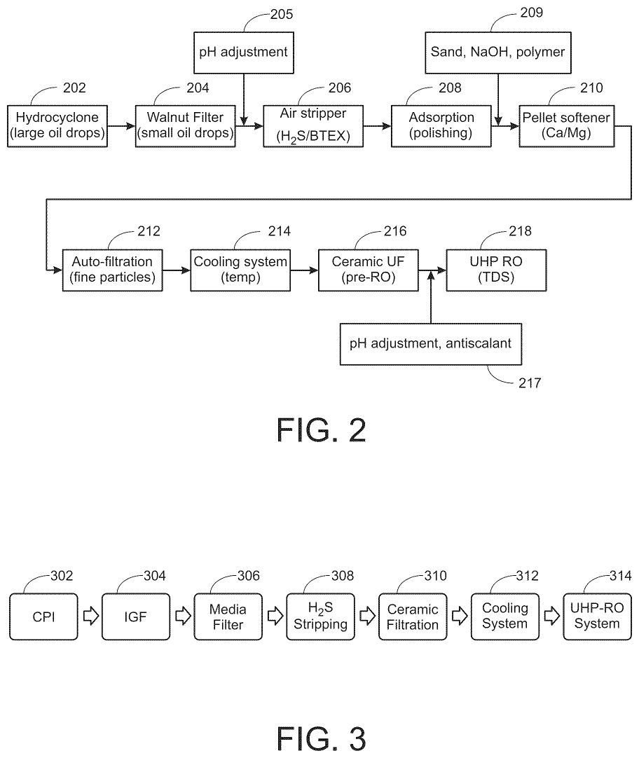

FIG. 2 is a block flow diagram of a sequence of pretreatment steps for the produced water from a water oil separator (WOSEP). The pH of the produced water from the WOSEP is lowered to convert the soluble organics to insoluble organics. At block 202, a hydrocyclone is used to remove large oil droplets. The hydrocyclone includes a conical chamber that has two outlets. The outlets are located at each end of the conical chamber. The produced water enters through a side inlet of the conical chamber. For example, the produced water is spun at a centrifugal force of 800-1000 times the force of gravity. The denser water phase is forced to the outer wall of the chamber and moves towards the bottom outlet from where it is discharged. The lighter oil phase moves to the center of the chamber and migrates upward towards the top outlet. The hydrocyclone removes oil droplets between 15-20 microns.

At block 204, a nut filter is used to remove small, emulsified oil droplets. In some implementations, pecan or walnut shell filters are used as they are more resistant to fouling. Crushed nutshells are packed in a bed within a vessel to form an intricate network that contain tortuous pathways. The produced water from the hydrocyclone flows through the nutshell filter. The nutshell offers oil coalescing and holding capacities by trapping the oil within the tortuous pore structure. The nutshell causes the small oil droplets to adsorb on its surface by providing a large contact area as the produced water flows through the tortuous pathway. Adsorption occurs due to the nature of the oil droplets and the surface of the nutshell. The produced water, free of the small and emulsified droplets are collected within the base of the vessel.

Maintenance of a nutshell filter is easy and a backwash process is used to remove the adsorbed oil from the nutshell filter. The nutshell filter removes oil droplets lesser than 15 microns in size. In some implementations, the nutshell media is regenerated by an automated sequence based on the pressure drop. In the automation process, the backwash system removes the adsorbed oil droplets to clean the filter and regenerate the media. At block 205, a pH adjustment is done to convert HS⁻ and S²⁻ into H₂S so that it becomes volatile and can easily be removed from water by stripping. Lowering the pH can also convert dissolved organics to insoluble organics to be separated from the water phase.

At block 206, an air stripper is used to remove dissolved sulfur containing gases from the produced water. Air stripping is also known as aeration. It mixes air with the produced water to volatilize contaminants. The volatile contaminants are directly released to the atmosphere or treated and released. Air stripping removes volatile organic compounds (VOCs). In some implementations, nitrogen, natural gas, or a suitable inert gas can be used for air stripping. Air stripping provides almost complete removal of the dissolved sulfur containing compounds, gases, and ammonia, with the shortest reaction time. In some implementations, chemicals are injected to remove the dissolved sulfur gases.

In some implementations, produced water includes hydrogen sulfide (H₂S), ammonia, benzene, toluene, ethylbenzene, and xylenes (BTEX). In such implementations, H₂S stripper is used. The H₂S stripper is a counter current spray tower where exchange between the produced water and gas takes place. Air or nitrogen can be used as the stripping medium to strip dissolved H₂S from the produced water. The obtained H₂S is of high purity and sent to the sulfur recovery unit (SRU). In some implementations, a second stripper is installed to recover ammonia, VOCs, and BTEX. In some implementations, the pH is adjusted to a value below 5 for stripping H₂S. Above pH 5, sulfur exists as ions. Similarly, the pH is adjusted to above 10 for efficient ammonia removal.

At block 208, adsorption media is used to remove dissolved organics. In some implementations, the pH of the produced water is lowered prior to the pretreatment step at block 202. The lowering of pH converts the dissolved organics into insoluble organics which helps with the removal of total petroleum hydrocarbons (TPH) by the adsorption media. In some implementations, the pH of the produced water is lowered prior to flowing into the adsorption media. Activated carbon is the medium of choice for removing dissolved organics from produced water. Activated carbon has a large surface area making it very effective for adsorption of organics and TPH. In some implementations, the activated carbon surface is modified to adsorb specific contaminants such as metals. In some implementations, zeolites are used as the adsorption medium. Zeolites are aluminosilicate minerals that have a crystalline structure. The dissolved organics include benzene, toluene, chlorinated aromatics, phenols, chlorinated aliphatics, high molecular weight hydrocarbons. In some implementations, silica gel, ion exchange resins, and polymeric adsorbents are used to remove dissolved organics. Adsorption process is a simple process to control. In some implementations, biological treatment methods are used when the TDS content of the produced water is low. Biological treatment methods require long residence time.

At block 209, sodium hydroxide (NaOH), micro sand, and polymer are added for softening water, i.e., to remove calcium and magnesium. They are fed into the pellet softener at block 210. The micro sand in a fluidized bed will act as a nuclei where the deposits of calcium carbonate (CaCO₃) form. NaOH is used to raise the pH to convert HCO₃⁻ into CO₃²⁻ form, which will form CaCO₃ to remove Ca. Polymer will cause the precipitates to stick together to form larger particles and remove residual Ca. Additionally, the high pH will form magnesium hydroxide Mg(OH)₂ which is a method to remove Mg. These precipitates will form pellets, which is easier to handle later.

At block 210, a pellet softener is used to remove hardness from the produced water. A pellet softener includes a tall vertical tank containing a seeding media. The commonly used seeding media is silica sand. In some implementations, the pellet softener includes a fluidized bed reactor. The key principle is the precipitation of multivalent cation carbonates. The reaction includes the precipitation of calcium carbonate (CaCO₃) and magnesium hydroxide (Mg(OH)₂) pellets. These pellets are formed on the silica sand particles.

The produced water is pumped through the vertical tank in an upward direction. The silica sand is in a fluidized state. Lye is pumped through another inlet in the tank and causes an increase in the pH to 10 in the tank. Due to the precipitation reaction, the hardness in the produced water is crystalized and precipitated out. During the operation, the height of the fluidized sand particles increases. The pellets become heavier and settle at the bottom of the tank. At frequent intervals, the pellets are withdrawn from the tank. Softening is an essential process to prevent scaling in the treatment units downstream of the pellet softener. In some implementations, nano filtration can be used for softening the produced water.

At block 212, an automatic filtration unit is used to remove fine colloidal particles. This removal prevents fouling load on the ceramic membrane, UHP-RO, or RO membranes in the desalination unit. Filtration process does not require a lot of chemicals and less sludge is generated during the process.

In some implementations, fine colloidal particles are removed by coagulation-flocculation followed by sand filter. This may need chemicals and water sludges are generated. This involves adding a chemical known as ‘coagulant’. The coagulant forms an aggregate of insoluble fine particles together by manipulating the charge on the particles. The insoluble particles form large aggregates called as ‘floc’. The coagulation process also aides in the adsorption of dissolved organic matter on the particle aggregates. In some implementations, coagulants used in the process include iron or aluminum salts. After the produced water is coagulated, the water can be moved to a settling tank in which the heavy particles settle at the bottom due to gravity. In some implementations, filters are used to remove the flocs.

At block 214, a heat exchanger or a cooling system is used to reduce the temperature of the produced water. The treated produced water from the automatic filtration unit is cooled down to 35-40° C. before flowing through a desalination unit. In some implementations, the cooling system includes the use of a cooling tower, a evaporative cooler, or a chiller. The cooling tower principle relies on water evaporation to dissipate heat to the environment, resulting in cooling the remaining water. In some implementations, multiple heat exchangers are installed in parallel or in series to cool the treated produced water. In some implementations, a combination of multiple heat exchangers and a cooling tower is used.

At block 216, a ceramic ultra filtration (UF) unit is used to remove the remaining dissolved oil and total suspended solids (TSS) from the treated produced water. Ceramic membrane provides almost complete removal of dissolved oil and TSS, while using the smallest amount of chemicals. It also generates the smallest quantities of waste during the process.

In some implementations, the ceramic UF is placed upstream of the cooling system. The ceramic UF can withstand high temperatures up to 90-100° C. However, the RO or UHP-RO membranes have a temperature limitation of 35-40° C. The RO membrane cannot tolerate oil or other contaminants. The membrane can get damaged due to fouling. Therefore, the ceramic UF unit is installed to remove the dissolved oils and other impurities prior to desalination. In some implementations, the treated produced water is at a temperature higher than 40° C. In some implementations, the treated produced water temperature can range between 40-60° C. In this case, the cooling system can be installed upstream of the ceramic UF. The produced water treatment sequence has sampling units installed at each block of the process. Adequate sampling ensures the specification of the produced water meets the pre-determined water quality prior to desalination. At block 217, pH adjustment is done and an antiscalant is added to ensure that there are no solids formed. The presence of solids can reduce the performance of the RO or UHP-RO membrane.

At block 218, the treated produced water undergoes desalination using an RO or UHP-RO. Desalination produces a permeate stream and a reject stream. The permeate stream has a reduced salinity and the reject stream has a high salinity. The desalination process removes the dissolved ions from the treated produced water stream. Up until the desalination step, the TDS of the produced water remains mostly unchanged from its original source in the geological oil reservoir formation.

The desalination process using an UHP-RO can reduce the TDS to less than 5000 ppm in a single pass through the UHP-RO membrane. In some implementations, based on the produced water feed TDS, the UHP-RO can reduce the TDS to a level between 500-2000 ppm. This depends on the produced water reuse purpose. In some implementations, the treated and desalinated produced water is reused as wash water in a desalter unit, which requires a TDS of 500-2000 ppm. In some implementations, the wash water unit is installed downstream of the desalination unit. The wash water unit receives the permeate stream of the desalination process. In some implementations, the treated and desalinated produced water is reused as boiler feed water, utility grade water, or potable water which requires a TDS below 500 ppm.

The UHP-RO can withstand pressures up to 1800 psi to overcome the osmotic pressure of the produced water that has a TDS range of 50,000-150,000 ppm. The UHP-RO consumes lower energy compared to the thermal desalination processes mentioned earlier. For high salinity produced water, the UHP-RO can recover water between 30-60%. For produced water with a TDS of 70,000 ppm, the UHP-RO consumes 5-6 kWh to produce one m³ of desalinated water. Thermal based technologies, such as multi-stage distillation (MED), multi-effect flash (MSF), and mechanical vapor compression (MVC) consume energy between 20-50 kWh to produce one m³ of desalinated water. Table 1 shows a software simulation results of treating a produced water using UHP-RO.

TABLE 1
Hydraunatics simulation data for desalination of produced water using
an UHP-RO, including input specifications of the booster pump.
Booster pump compaction specifications (95° F.)

| HP pump flow | 311.50 | gpm | Raw water flow/train | 311.50 | gpm |
|---|---|---|---|---|---|
| Feed pressure | 1435.0 | psi | Permeate recovery | 51.50% | |
| Feed temperature | 35.0 | C. | Membrane age | 1.0 | years |
| Feed Water pH | 6 | | Flux decline, per year | 7.00% | |
| Chemical dose, mg/L, 100% | 280.11 | H₂SO₄ | Fouling factor | 0.93 | |
| Pumping specific energy | 28.42 | kWh/kgal | SP increase, per year | 10.00% | |
| Pass NDP | 516.4 | psi | Inter-stage pipe loss | 0.000 | psi |

| | | | | |
|---|---|---|---|---|
| Average flux | 7.0 | gfd | Feed type | Industrial Waste |
| Permeate flow/train | 160.42 | gpm | Pretreatment | Conventional |

| | Perm | Flow/Vessel | | | | Flux | | |
|---|---|---|---|---|---|---|---|---|
| Pass | Flow | Feed | Conc | Flux | DP | Max | | Perm |
| Stage | gpm | gpm | gpm | gfd | psi | gfd | Beta | psi |
| 1-1 | 119.2 | 34.6 | 21.4 | 8.7 | 9.1 | 14.6 | 1.04 | 0 |
| 1-2 | 41.2 | 32.1 | 25.2 | 4.5 | 9.5 | 6.5 | 1.02 | 0 |

| Stagewise Pressure | | | | Membrane Type, Qty, and | | |
|---|---|---|---|---|---|---|
| Boost | Exhaust | Conc | | Element | | |
| psi | psi | psi | TDS | Type | Qty | PV# |
| 0 | 0 | 0 | 1182.3 | PRO-XP1 | 54 | 9x6M |
| 0 | 200 | 0 | 3103.3 | PRO-XP1 | 36 | 6x6M |

| Ion (mg/L) | Raw Water | Feed Water | Permeate Water | Concentrate 1 | Concentrate 2 |
|---|---|---|---|---|---|
| Hardness as CaCO₃ | 15569.26 | 15569.26 | 56.197 | 25189.7 | 32018.4 |
| Ca | 5090 | 5090 | 18.372 | 8235.2 | 10467.6 |
| Mg | 694 | 694 | 2.505 | 1122.8 | 1427.2 |
| Na | 17246.65 | 17246.65 | 592.634 | 27672.4 | 34905.2 |
| K | 756 | 756 | 32.396 | 1210.2 | 1523.2 |
| Ba | 2.28 | 2.28 | 0.008 | 3.7 | 4.7 |
| Sr | 200 | 200 | 0.722 | 323.6 | 411.3 |
| H | 0 | 0 | 0.015 | 0 | 0 |
| CO₃ | 2.9 | 0.15 | 0 | 0.4 | 0.7 |
| HCO₃ | 707.6 | 357.29 | 16.665 | 568.7 | 711.5 |
| SO₄ | 1220 | 1494.39 | 9.789 | 2415.9 | 3068.6 |
| Cl | 36800 | 36800 | 959.077 | 59179.3 | 74802.9 |
| F | 3.8 | 3.8 | 0.859 | 5.7 | 6.9 |
| SiO₂ | 75.2 | 75.2 | 2.054 | 120.9 | 152.8 |
| B | 20.5 | 20.5 | 26.552 | 18.5 | 14.1 |
| CO₂ | 63.9 | 317.6 | 317.6 | 317.6 | 317.6 |

FIG. 3 is a block flow diagram of a pretreatment process using corrugated plate inceptor (CPI) and IGF (induced gas floatation unit) for the removal of oil and TSS. At block 302, a CPI is used to remove free oil suspended and TSS in the produced water stream. CPI are separators that are used to separate and remove free oil or suspended solids from the produced water. The CPI relies of the principle of differences in densities. The denser phase such as water will settle at the bottom and the lighter phase such as oil will float on the top. In some implementation, CPI can be tilted at an angle. A CPI is very efficient and needs very low maintenance.

At block 304, an IGF/or dissolved gas floatation (DGF) is used to remove small and remaining oil droplets and TSS. An IGF operates on a principle very similar to the CPI. In an IGF or DGF, a stream of gas bubbles is introduced. The suspended oil or solids adhere to the surface of the gas bubbles and are skimmed off. In some implementations, nitrogen gas is used to create bubbles instead of air. In other implementations, inert gases are used to create the bubbles. A CPI and IGF/DGF provides effective removal of free and suspended oil and offers a stable process. In some implementations where CPI and IGF are used, an adsorption media, softener, or automatic filtration unit may not be necessary. This depends on the inlet produced water quality. Chemicals including coagulant and flocculant are added as part of the system.

At block 306, a media filter is used to remove dissolved organics and metals founds in the produced water. In some implementations, depending on the produced water quality, a media filter is required to remove the dissolved organics, sediments, iron, or chlorine. The media filter includes materials like sand, gravel, anthracite, ceramic media, activated alumina, synthetic media, nutshell, or activated carbon.

At block 308, a H₂S stripper or an air stripper is used to remove dissolved gases from the produced water. As described earlier, the H₂S stripper is a counter current spray tower where exchange between the produced water and gas takes place. Air or nitrogen can be used as the stripping medium to strip dissolved H₂S from the produced water. The obtained H₂S is of high purity and sent to the sulfur recovery unit (SRU). In some implementations, a second stripper in installed to recover ammonia, VOCs, and BTEX using steam.

At block 310, a ceramic filtration similar to the one described in FIG. 2 is installed. The ceramic membrane filtration is used to remove the remaining dissolved oil and total suspended solids (TSS) from the treated produced water. In some implementations, the ceramic membrane is placed upstream of the cooling system. The ceramic membrane can withstand high temperatures up to 90-100° C.

At block 312, a cooling system similar to the system described in FIG. 2 is installed. The cooling system includes a cooling tower, evaporative chiller, or multiple heat exchangers connected in series or parallel. The RO or UHP-RO membrane used in the desalination unit has a temperature limitation of 35-40° C. The sequence may have variations, such as the location of the ceramic membrane and the cooling system. The ceramic membrane upstream of the cooling system may have an advantage to reduce the size of the cooling system and reduce fouling. Only ceramic membranes can withstand high temperature. If cooling is used upstream of the membrane filtration, other types of membranes such as polyvinylidene fluoride (PVDF) can be used, which may be more economical on the low-pressure membrane side, but the cooling system will need to be larger.

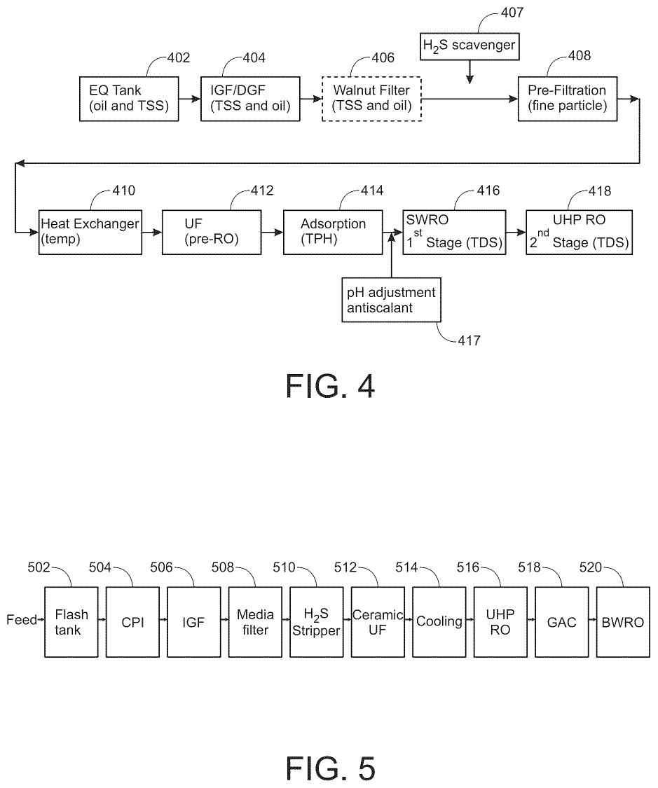

FIG. 4 is a block flow diagram of a sequence of pretreatment steps for produced water from a WOSEP that utilizes an equalization (EQ) tank. At block 402, a EQ tank is added in locations where the produced water quality and quantity may have high variations and it is necessary to even out the feed. An EQ tank is utilized when multiple produced water streams from the GOSP enter the pretreatment unit. EQ tank provides hydraulic and contaminant load buffering for the processes in the sequence of pretreatment units. In some implementations, the produced water stream is screened for large solids to prevent build up in the EQ tank. In some implementations, the pH is adjusted in the EQ tank prior to the treatment steps.

At block 404, an IGF or dissolved gas floatation (DGF) is used to remove free and suspended oil. In a DGF micro bubbles are introduced to enhance the separation surface area. A pressurized partially saturated produced water steam with gas is introduced. Subsequently the produced water stream is exposed to atmospheric pressure, which creates micro bubbles. The oil droplets and total suspended solids (TSS) adhere to the micro bubbles surface. These contaminants are skimmed off when the bubbles float to the top.

At block 406, a nutshell filter is used to remove the remaining oil particles. As described in FIG. 2, a nutshell filter can include crushed walnut or pecan shells which are packed in a tank. The packing creates a tortuous path. The surface of the nutshell adsorbs the oil and suspended solids. The small and emulsified oil droplets are removed and the produced water is removed from the bottom of the tank. At block 407, a H₂S scavenger is introduced to remove the dissolved H₂S ions.

At block 408, a pre-particle filtration unit is placed to remove the fine colloidal particles. In some implementations an automatic filtration system is used. Silt Density Index (SDI) is a measure of the rate of clogging or fouling a membrane. Fine colloidal particles cause plugging and fouling of the UF, RO, or UHP-RO membrane. To prevent the plugging of the membrane, the pre-particle filtration unit treats the produced water to remove fine particles. These particles are in the micron size range. Prior or pre-filtration, H₂S scavengers are added to remove the dissolved H₂S ions.

At block 410, a heat exchanger or a cooling tower is used to reduce the temperature of the treated produced water. Certain types of low pressure membranes, or RO and UHP-RO membranes have a temperature limitation of 35-40° C. The high temperature of the produced water can damage the RO/UHP-RO membrane. Therefore, cooling the treated produced water is essential.

At block 412, an ultra-filtration (UF) unit is installed to remove colloidal particles in the 0.01-1 micron range and some dissolved contaminants. The process is similar to an RO mechanism, where the produced water is forced through a semi-permeable membrane. This pressure driven process is used to remove bacteria, viruses, suspended solids, and fine colloidal particles. In some implementations, ceramic UF is used. A ceramic UF can withstand higher temperatures.

At block 414, adsorption unit is used to remove dissolved organics and TPH. This unit is added after the UF membrane to remove TPH. This minimizes damages to the RO or UHP-RO membrane. As described in FIG. 2, the adsorption media includes activated carbon, polymeric resins, zeolites, or silica gel. The type of adsorption media used depends on the produced water quality. At block 417, pH adjustment chemicals and an antiscalant are added to ensure that no solids (scaling) are formed. The presence of solids can reduce the performance of the RO or UHP-RO membrane.

At block 416, a sea water reverse osmosis (SWRO) is installed as a first stage of TDS removal in the desalination process. This process uses a semi-permeable membrane to flow the treated produced water through it. The SWRO has a limit of 40,000-50,000 ppm of TDS removal. When the TDS content of the produced water is higher than 50,000 ppm, a double stage RO is helpful in reducing the TDS levels to values suitable for reuse in the GOSP. The SWRO produces a permeate stream and a reject stream. Water recovery rate by this process is 20-40%.

At block 418, a UHP-RO is installed for the second stage desalination. The UHP-RO can lower the TDS from up to 150,000 ppm to less than 5000 ppm. The desalination process produces a permeate and reject stream. In some implementations, a portion of the permeate stream which has a lower TDS is recycled back to the wash water unit. This permeate stream is used to desalt crude and helps conserve the use of freshwater sources.

FIG. 5 is a block flow diagram of a sequence of pretreatment stages that uses a flash tank to stabilize the pressure of the incoming produced water. At block 502, a flash tank is installed for cases where the influent produced water carries pressures between 1-200 psi. A flash tank is used to reduce the pressure for the system to operate properly.

At block 504, a CPI is used to remove free and large oil droplets and suspended solids. As mentioned in FIG. 3, CPIs are separators that are used to separate and remove free oil or suspended solids from the produced water. The CPI relies of the principle of differences in densities. The oil droplets float to the top and water settles at the bottom.

At block 506, an IGF (or DGF) is used to remove TSS, emulsified and smaller oil droplets. As mentioned in FIG. 3, an IGF operates on a principle very similar to the CPI. In an IGF or DGF, a stream of gas bubbles is introduced. The suspended oil or solids adhere to the surface of the gas bubbles and are skimmed off. In some implementations, nitrogen gas is used to create bubbles instead of air.

At block 508, a media filter is used to removed dissolved organics from the produced water. The media can include activated carbon, modified activated carbon, silica gel, polymeric resins, zeolites, or synthetic media. Some of these media are chemically modified to adsorb specific organic compounds. The organic compounds removed are benzene, toluene, chlorinated aromatics, phenols, chlorinated aliphatics, high molecular weight hydrocarbons.

At block 510, a H₂S stripper is used to remove dissolved H₂S gas. As mentioned in FIG. 2, a H₂S stripper is a counter current spray column, where air or nitrogen are used as the stripping medium. The H₂S gas moves towards the top of the column and is removed. In some implementations, a second stripping column to remove ammonia is used to remove dissolved ammonia from the produced water.

At block 512, a ceramic ultra filtration (UF) is used to remove the remaining dissolved oil and organics, which were not removed by the IGF, DGF, or media filter. The ceramic UF can withstand high temperatures in the range of 90-100° C. In some implementations, the ceramic UF is placed upstream of the RO or UHP-RO membrane to minimize fouling. In such implementations, the cooling system size is reduced.

At block 514, a cooling system is placed to reduce the temperature of the pretreated produced water. As described in FIG. 2 and FIG. 3, the cooling system includes a cooling tower, evaporative chiller, or multiple heat exchangers. In some implementations, the heat exchangers are connected in series or parallel. The cooling system is selected based on the availability of the cooling media. In some implementations, the permeate stream and the reject stream from the desalination unit is used as the cooling media for the heat exchangers. In some implementations, a groundwater source is used as the cooling medium for the heat exchangers. In some implementations, a combination of heat exchangers and a cooling tower is utilized to cool the pretreated produced water. The main purpose of the cooling system is to protect the RO or the UHP-RO membrane from thermal damage. The RO and UHP-RO have a temperature limitation of 35-40° C.

At block 516, the RO or UHP-RO is used for the desalination of the pretreated produced water. A detailed explanation along with simulation model data is provided in the description of FIG. 2. The RO or UHP-RO reduces the TDS of the pretreated produced water from 50,000-150,000 ppm to less than 5000 ppm in a single pass. The desalination process produces a permeate stream and a reject stream.

At block 518, a granulated activated carbon (GAC) filter is installed. The permeate from the UHP-RO can be further treated using a GAC when a higher quality application such as firefighting water or cooling water is needed in the oil and gas facility. GAC is primarily made up of organic material rich in carbon such as coconut shells, coal, peat, or wood. GAC is used to remove chemicals, organic contaminants, per or polyfluoroalkyl substances. The granular activated carbon has a very high surface area which enhances adsorption of organic compounds when the desalinated produced water passes through it.

At block 520, brackish water reverse osmosis (BWRO) process is used to further purify the desalinated produced water. In BWRO a pressure of 30-250 psi is applied on the semi-permeable membrane to reduce the TDS in the pretreated or desalinated produced water. In some implementations, the GAC and BWRO are used in combination with the RO or UHP-RO. In some implementations, a BWRO is placed downstream of the UHP-RO without the GAC. Generally, water having a TDS of 3000-8000 ppm is considered brackish water. In some implementations, such as utility grade water, potable drinking water, or boiler feed water requires very low TDS content in the order of 500-1500 ppm. In such cases a BWRO is preferrable.

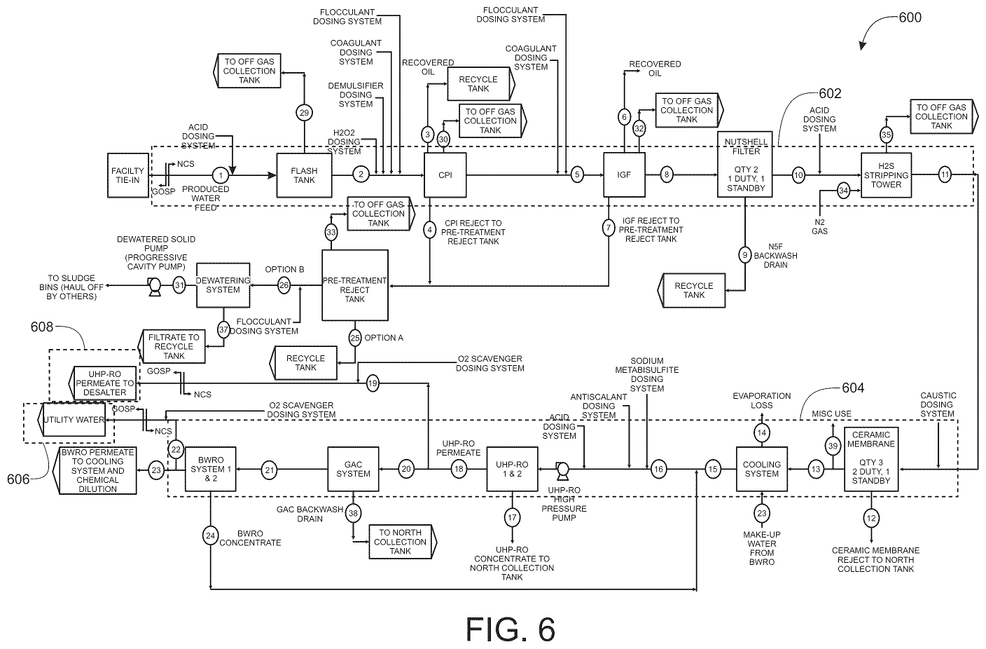

FIG. 6 is a process flow diagram of a GOSP operation for the pretreatment of produced water and desalination using a UHP-RO. At block 602, the produced water from a GOSP facility is processed by a flash tank. A flocculant, coagulant, and demulsifier are added to the outlet stream from the flash tank. A flocculant and coagulant create an aggregate of suspended solids which are skimmed off later. A demulsifier helps to break the oil in water emulsions. The demulsifier can include a cationic or anionic surfactant along with a solvent like alcohol.

The free oil and suspended solids are removed by a CPI. The TSS and emulsified and small oil droplets are removed by the IGF or DGF. The nutshell filter removes the remaining TSS and oil from the produced water and dissolved gases like H₂S, ammonia, VOCs, BTEX are removed by a H₂S stripping tower and a secondary stripping tower. In between the flash tank and the CPI, and the CPI and IGF/DGF, coagulants and flocculants are dosed in small quantities to remove the remaining suspended solid particles.

At block 604, small quantities of alkali are dosed to remove the hardness from the produced water. The produced water is then processed by the ceramic membrane to remove precipitates, dissolved organics, and dissolved oil that was already not removed by the IGF or DGF. In some implementations, an adsorption media is placed upstream of the ceramic membrane.

Following the ceramic membrane, the produced water is cooled down by the cooling system and desalinated to reduce the TDS to levels appropriate for reuse in the GOSP facility. In some implementations, a biocide, corrosion inhibitor, anti-foam agent, and scale inhibitors are added to the cooled produced water flowing out of the cooling system. In some implementations, the pretreated produced water, prior to desalination, is sent to the injection for use for enhanced oil recovery purposes. In implementations shown in the FIG. 6, the desalination process utilizes a UHP-RO membrane. The desalination process produces a permeate stream and a reject stream.

The permeate stream is further processed by a GAC system and BWRO. A portion of the produced water (i.e., reject stream) from the BWRO is recycled back to the UHP-RO for further desalination. In some implementations, the produced water from the BWRO is sent to the cooling system and further purified by the addition of chemicals. Post the BWRO stage, oxygen scavengers are dosed into the water in ppm levels to prevent bacterial and other microbe growth in the produced water. This is essential when the treated and desalinated produced water is used for utility purposes in the utility unit at block 606.

At block 608, the desalinated water from the BWRO is sent for utility water purposes such as for firefighting applications, potable water, boiler feed water etc. At block 608, a portion of the permeate stream from the UHP-RO is recycled and reused as a wash water stream for the desalter unit. Detailed description of the unit operations in the process flow diagram are mentioned in FIGS. 2-5.

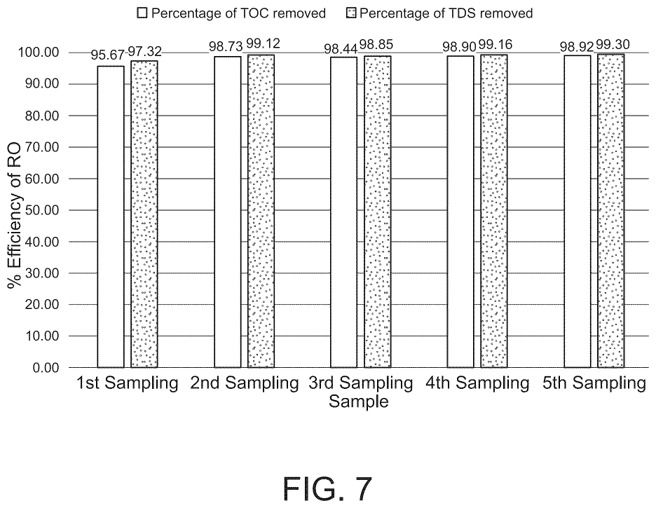

FIG. 7 is the experimental results of the UHP-RO showing the efficiency of removal of total dissolved solids (TDS) and total organic carbon (TOC). The graph shows the results of five sampling points of the produced water that is desalinated using a UHP-RO. The efficiency of TDS removal is between 97-99.3% and the efficiency of TOC removal is between 95-98.9%. This demonstrates that the UHP-RO removes close to 99% of the TDS and TOC. Therefore, the produced water can be reused as a wash water for the desalter, as it has the required salinity by the sequence of pretreatment steps and desalination by UHP-RO.

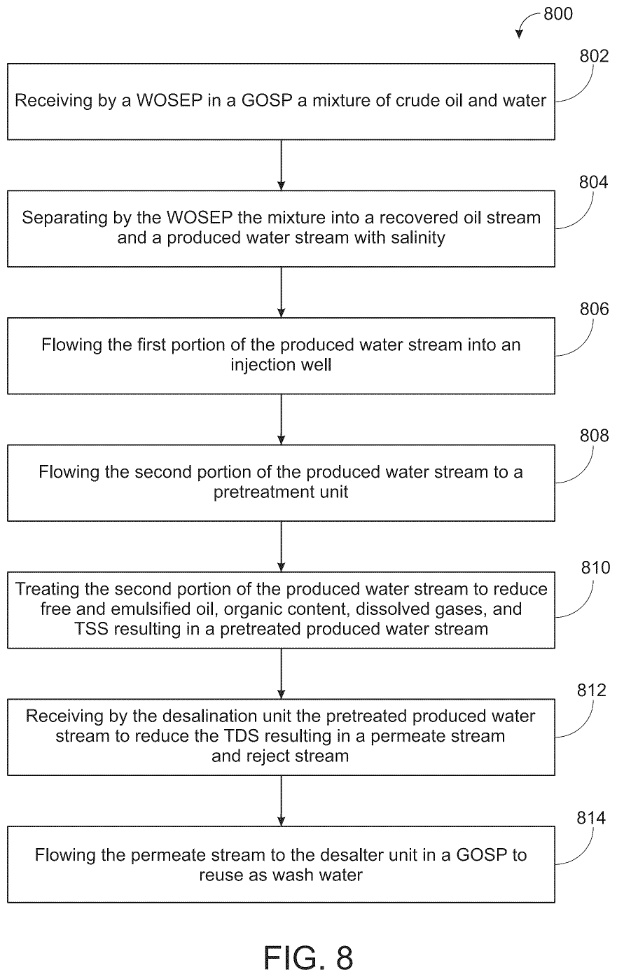

FIG. 8 is a process flow of the proposed technology for a GOSP process to reuse the produced water as a wash water for desalting the crude oil. At block 802, the water oil separator (WOSEP) in a GOSP receives a mixture of crude oil along with water. The water is mainly from the formation brine and the pumping fluids injected into the well. At block 804, the WOSEP separates the mixture of crude oil and water into a recovered oil stream and a produced water stream. The produced water stream has a salinity which depends on the geological formation, the formation brine, and chemicals used in the injected fluids.

At block 806, a first portion of the produced water is sent to the injection well for either pressure maintenance, used as an injection fluid for enhanced oil recovery purposes, or as a fluid for fracking operations. At block 808, a second portion of the produced water stream is processed by a pretreatment unit. The pretreatment unit includes any combination and any sequence of a hydroclone, nutshell filter, a gas stripper, an adsorption media, a pellet softener, an automatic filtration unit, a MF/UF ceramic membrane, a sampling unit.

At block 810, the second portion of the produced water stream is treated to remove several contaminants such as free and emulsified oil, organic content, dissolved gases, and total suspended solids (TSS). This results in a pretreated produced water stream.

At block 812, the pretreated produced water stream is received by the desalination unit. The desalination unit includes a RO or UHP-RO membrane. In some implementations, the desalination unit includes a nanofiltration membrane. Desalination produces a permeate stream and a reject stream. The reject stream contains most of the TDS and has a high salinity. The permeate stream has a lower salinity after the TDS is rejected into the reject stream. In some implementations, the RO or UHP-RO membrane has a separation efficiency of approximately 99%. In a single pass the RO or UHP-RO membrane can desalinate the pretreated produced water and reduce the TDS from up to 150,000 ppm to less than 5000 ppm.

At block 814, the permeate stream containing less than 5000 ppm of TDS is recycled to the desalter unit of the GOSP, to be reused as a wash water stream to desalt crude oil. Desalting crude oil is essential to prevent corrosion and scaling of the downstream processing units and the shipment lines.

### Examples

Certain aspects of the subject matter described here can be implemented as a method in a GOSP. A mixture of crude oil and water is received by a GOSP. The WOSEP separates the mixture into a recovered oil stream and a produced water stream having salinity. A first portion of the produced water stream is flowed into an injection well. A second portion of the produced water stream is flowed into a pretreatment unit integrated in the GOSP. The pretreatment unit treats the second portion of the produced water stream to reduce a free and emulsified oil content, an organic content, a dissolved gas, and a total suspended solids, resulting in a pretreated produced water stream. The desalination unit includes a RO or UHP-RO membrane, where the TDS is reduced to produce a permeate stream and a reject stream. The permeate stream from the desalination unit is flowed as a wash water stream into a desalter unit in the GOSP, to desalt crude oil.

An aspect combinable with any other aspect includes the following features. The salinity of the produced water stream is between 50,000-150,000 ppm of TDS.

An aspect combinable with any other aspect includes the following features. The pH of the second portion of the produced water stream is lowered prior to flowing to the pretreatment unit. The lowering of the pH converts the soluble organics to insoluble organics which helps in removing TPH.

An aspect combinable with any other aspect includes the following features. The second portion of the produced water stream is flowed into the pretreatment unit. The pretreatment unit includes a particular sequence of steps that includes, removing TSS and large oil droplets. This is followed by removing remaining TSS and small oil droplets. This is followed by removing dissolved H₂S and VOCs. This is followed by removing dissolved organics, hardness, and fine colloidal particles. This is followed by cooling the second portion of the produced water stream. After cooling the second portion of the produced water stream, the dissolved oil and remaining TSS are removed.

An aspect combinable with any other aspect includes the following features. The TSS and large oil droplets are removed using a hydrocyclone. The remaining TSS and small oil droplets are removed using a nutshell filter. The dissolved H₂S and VOCs are removed using a gas stripper. The dissolved organics are removed using an adsorption media. The hardness is removed using a pellet softener. The fine colloidal particles are removed using an auto-filtration unit. The temperature of the second portion of the produced water stream is reduced using a cooling system. The dissolved oil is removed using a ceramic ultra filtration membrane, prior to flowing the pretreated produced water stream to the RO or UHP-RO membrane in the desalination unit.

An aspect combinable with any other aspect includes the following features. Alternatively the hydroclone and nutshell filter are replaced with a CPI, a gas floatation unit, and a media filter depending on the second portion of the produced water stream quality.

An aspect combinable with any other aspect includes the following features. The ceramic ultra filtration membrane is placed upstream of the cooling system.

An aspect combinable with any other aspect includes the following features. An EQ tank is placed upstream of the gas floatation unit

An aspect combinable with any other aspect includes the following features. The second portion of the produced water stream is flowed through a flash tank upstream of the CPI to reduce a pressure of the second portion of the produced water stream.

An aspect combinable with any other aspect includes the following features. The second portion of the produced water stream has a pressure of 1-200 psi.

An aspect combinable with any other aspect includes the following features. The permeate stream from the desalination unit is flowed through a GAC filter and a BWRO to increase the purity of the permeate stream.

An aspect combinable with any other aspect includes the following features. An adsorption media is placed downstream of the ceramic ultra filtration membrane to remove TPH.

Certain aspects of the subject matter described here can be implemented as a pretreatment system in a GOSP. The system includes a sequence of units: a hydroclone to remove large oil droplets and TSS; a nutshell filter to remove small oil droplets and remaining TSS; a H₂S gas stripper to remove dissolved sulfur containing compounds and VOCs; an adsorption media to remove dissolved organics and TPH; a pellet softener to remove hardness to avoid scaling; an automatic filter to remove fine colloidal particles; a ceramic ultra filtration membrane to remove dissolved oil; a cooling system including heat exchangers or an evaporative cooling tower to bring down the temperature of the produced water stream; a sampling unit to check if the produced water stream meets a pre-determined produced water quality; a desalination unit placed downstream that includes a UHP-RO membrane or RO membrane to remove total dissolved ions. After desalination a permeate stream and a reject stream is formed. A wash water unit is installed downstream of the desalination unit, which receives the permeate stream to be used as a wash water stream to desalt crude oil.

An aspect combinable with any other aspect includes the following features. The produced water stream has a salinity up to 150,000 ppm TDS.

An aspect combinable with any other aspect includes the following features. The hydroclone and the nutshell filter are replaced with a corrugated plate CPI, a gas floatation unit, and a media filter depending on the produced water stream quality.

An aspect combinable with any other aspect includes the following features. The ceramic ultra filtration membrane is placed upstream of the cooling system to reduce the size of the cooling system.

An aspect combinable with any other aspect includes the following features. An EQ tank is installed upstream of the gas floatation unit and a flash tank is installed upstream of the CPI to reduce the pressure. The produced water stream has a pressure of 1-200 psi.

An aspect combinable with any other aspect includes the following features. A GAC filter and a BWRO are included, where the permeate stream from the desalination unit flows through the GAC and the BWRO resulting in a higher purity of the produced water stream.

An aspect combinable with any other aspect includes the following features. A sampling system is installed in between each unit to check the produced water stream quality before proceeding to the desalination unit.

Certain aspects of the subject matter described here can be implemented as a method to treat produced water stream in a GOSP. The method includes flowing the produced water stream to a pretreatment unit integrated in the GOSP. The steps further include removing large oil droplets and TSS, followed by removing small oil droplets and the remaining TSS. This is followed by removing dissolved H₂S and VOCs. This is followed by removing dissolved organics and hardness. This is followed by removing fine colloidal particles. The produced water stream is cooled. Following the cooling, the dissolved oil and TDS are removed. A pretreated produced water stream is received by the desalination unit. The desalination unit includes a RO or an UHP-RO membrane, where the RO or UHP-RO membrane produce a permeate stream and a reject stream. The permeate stream from the desalination unit is flowed as a wash water stream to a desalter unit in the GOSP to desalt crude oil. In some implementations, the permeate stream is used as boiler feed water, potable water, or utility water.

Other implementations are also within the scope of the following claims.

What is claimed is:

1. A method comprising:
receiving, by a water oil separator in a gas oil separation plant (GOSP), a mixture of crude oil and water;
separating, by the water oil separator, the mixture into a recovered oil stream and a produced water stream having salinity;
flowing a first portion of the produced water stream to an injection well;
flowing a second portion of the produced water stream to a pretreatment unit integrated in the GOSP;
treating, by the pretreatment unit, the second portion of the produced water stream to reduce a free and emulsified oil content, an organic content, a dissolved gas, and a total suspended solids, resulting in a pretreated produced water stream;
receiving, by the desalination unit, the pretreated produced water stream, wherein the desalination unit comprises a reverse osmosis (RO) or ultra-high pressure reverse osmosis (UHP-RO) membrane; wherein the desalination reduces the total dissolved solids (TDS) to produce a permeate stream and a reject stream,
flowing the permeate stream from the desalination unit as a wash water stream to a desalter unit in the GOSP to desalt the crude oil.

2. The method of claim 1, wherein the salinity of the produced water stream is between 50,000-150,000 parts per million (ppm) of total dissolved solids (TDS).

3. The method of claim 1, further comprising lowering a pH of the second portion of the produced water stream, prior to flowing to the pretreatment unit, to convert soluble organics to insoluble organics for removing total petroleum hydrocarbons (TPH).

4. The method of claim 1, further comprising flowing the second portion of the produced water stream to the pretreatment unit, wherein the pretreatment unit implements a sequence, wherein the pretreatment unit implements a sequence for removing total suspended solids (TSS) and large oil droplets; after removing TSS and large oil droplets, removing remaining TSS and small oil droplets; after removing remaining TSS and small oil droplets, removing dissolved H₂S and volatile organic compounds (VOCs); after removing dissolved H₂S and VOCs, removing dissolved organics; after removing dissolved organics, removing hardness; after removing hardness, removing fine colloidal particles; after removing fine colloidal particles, cooling the second portion of the produced water stream; after cooling the second portion of the produced water stream, removing dissolved oil.

5. The method of claim 4, wherein TSS and large oil droplets are removed using a hydrocyclone, wherein remaining TSS and small oil droplets are removed using a nutshell filter, wherein the dissolved H₂S and VOCs are removed using a gas stripper, wherein the dissolved organics are removed using an adsorption media, wherein the hardness is removed using a pellet softener, wherein the fine colloidal particles are removed using an auto-filtration unit, wherein the temperature of the second portion of the produced water stream is reduced using a cooling system, and wherein the dissolved oil and remaining TSS are removed using a ceramic ultra filtration membrane in this sequence or in other combinations, before flowing the pretreated produced water stream to the RO or UHP-RO membrane in the desalination unit.

6. The method of claim 5, further comprising alternatively replacing the hydrocyclone and nutshell filter with a corrugated plate inceptor (CPI), gas floatation unit, and a media filter depending on the second portion of the produced water stream quality.

7. The method of claim 5, further comprising placing the ceramic ultra filtration membrane upstream of the cooling system.

8. The method of claim 6, further comprising placing an EQ tank upstream of the gas floatation unit.

9. The method of claim 6, further comprising flowing the second portion of the produced water stream through a flash tank upstream of the CPI to reduce a pressure of the second portion of the produced water stream.

10. The method of claim 9, wherein the second portion of the produced water stream has a pressure of 1-200 psi.

11. The method of claim 1, further comprising flowing the permeate stream from the desalination unit through a granular activated carbon (GAC) filter and brackish water reverse osmosis (BWRO) to increase a purity of the permeate stream.

12. The method of claim 5, further comprising an adsorption media downstream of the ceramic ultra filtration membrane to remove total petroleum hydrocarbons (TPH).

13. A pretreatment system for a produced water stream in a gas oil separation plant (GOSP) comprising:
a sequence of units:
a hydroclone to remove large oil droplets and total suspended solids (TSS);
a nutshell filter to remove small oil droplets and remaining TSS;
a H₂S gas stripper to remove dissolved sulfur containing compounds and volatile organic compounds (VOCs);
an adsorption media to remove dissolved organics and total petroleum hydrocarbons (TPH);
a pellet softener to remove hardness to avoid scaling;
an automatic filter to remove fine colloidal particles;
a ceramic ultra filtration membrane to remove dissolved oil and remaining TSS;
a cooling system comprising heat exchangers or an evaporative cooling tower to bring down the temperature of the produced water stream;
a sampling unit to check if the produced water stream meets a pre-determined produced water quality;
a desalination unit placed downstream comprising a ultra-high pressure reverse osmosis (UHP-RO) membrane or reverse osmosis membrane (RO) to remove the total dissolved ions, wherein after desalination a permeate stream and a reject stream is formed; and
a wash water unit installed downstream of the desalination unit, which receives the permeate stream to be used as a wash water stream to desalt crude oil.

14. The pre-treatment system of claim 13, wherein the produced water stream has a salinity up to 150,000 ppm of total dissolved solids (TDS).

15. The pre-treatment system of claim 13, wherein the hydroclone and the nutshell filter are replaced with a corrugated plate inceptor (CPI), a gas floatation unit, and a media filter depending on the produced water stream quality.

16. The pre-treatment system of claim 13, wherein the ceramic ultra filtration membrane is placed upstream of the cooling system to reduce the size of the cooling system.

17. The pre-treatment system of claim 15, further comprising an EQ tank installed upstream of the gas floatation unit and a flash tank installed upstream of the CPI to reduce the pressure, wherein the produced water stream has a pressure of 1-200 psi.

18. The pre-treatment system of claim 13, further comprising a granular activated carbon (GAC) filter and a brackish water reverse osmosis (BWRO), wherein the permeate stream from the desalination unit flows through the GAC and the BWRO resulting in a higher purity of the produced water stream.

19. The pre-treatment system of claim 13, wherein a sampling system is installed in between each unit to check the produced water stream quality before proceeding to the desalination unit.

20. A method to treat a produced water stream comprising:
flowing the produced water stream to a pretreatment unit integrated in the gas oil separation plant (GOSP), further comprising:
removing large oil droplets and total suspended solids (TSS);
after removing large oil droplets and TSS, removing small oil droplets and remaining TSS;
after removing small oil droplets, removing dissolved H₂S and volatile organic compounds (VOCs);
after removing dissolved H₂S and VOCs, removing dissolved organics;
after removing dissolved organics, removing hardness;
after removing hardness, removing fine colloidal particles;
after removing fine colloidal particles, cooling the produced water stream;
after cooling the produced water stream, removing dissolved oil and remaining TSS;
receiving a pretreated produced water stream by a desalination unit comprising a reverse osmosis (RO) or an ultra-high pressure reverse osmosis (UHP-RO) membrane to remove total dissolved solids (TDS), wherein the RO or UHP-RO produces a permeate stream and a reject stream; and
flowing the permeate stream from the desalination unit as a wash water stream to a desalter unit in the GOSP to desalt crude oil.
